(19) United States
(12) Patent Application Publication
(10) Pub. No.: US 2026/0012131 A1
(43) Pub. Date: Jan. 8, 2026

(54) LUMINESCENT SOLAR CONCENTRATOR ENHANCED PANELS (LSC) THROUGH CONCENTRATION AND FUNNEL REFLECTION

(71) Applicant: Claudio Romagnoli, Monte San Vito (AN) (IT)

(72) Inventor: Claudio Romagnoli, Monte San Vito (AN) (IT)

(73) Assignee: Claudio Romagnoli, Monte San Vito (AN) (IT)

(21) Appl. No.: 18/993,593

(22) PCT Filed: Jul. 13, 2023
(86) PCT No.: PCT/IT2023/050161

§ 371 Date: Jan. 13, 2025

(30) Foreign Application Priority Data
Jul. 15, 2022 (IT) 102022000014764

(51) Int. Cl. H02S 40/22

(52) U.S. Cl. CPC H02S 40/22

(57) ABSTRACT

The invention involves the development of an enhanced luminescent concentrator solar panel using a specific method to capture and concentrate the maximum percentage of solar energy. The solution is a luminescent solar panel that absorbs all incident energy without dispersion on the opposite side (no semi-transparency). This enhanced luminescent solar concentrator operates with sunlight and is made up of a transparent material, a specific distribution of composite pigment consisting of diffusive and reflective elements with an intermediate layer reflecting solar light, photovoltaic strips positioned at the lateral edges of the transparent portion, and a reflective base. Solar light incident on the panel is diffused by the pigment and trapped in the underlying part through a funnel-shaped region and the reflection between the intermediate layer and the lower reflective base of the panel. The trapped light remains concentrated and is transferred to the photovoltaic elements through reflection. This invention is innovative because it allows for the creation of an enhanced luminescent concentrator solar panel (LSC) that absorbs the majority of incident energy, reducing losses. This application is highly effective as it can be used as a coating for opaque surfaces (non-glass) in green energy generation. These results are achieved without the need for expensive materials or equipment, thanks to the synergies among the constituent parts, making it ready for immediate industrialization.

### a. THE TECHNICAL FIELD

The present invention is used for applications related to the production of green energy in urban, commercial, and industrial buildings. It can be used on all vertical and horizontal surfaces of buildings, as it aims to be a coating that generates energy.

### b. SECTORIAL BACKGROUND

Luminescent solar concentrators are born out of the need to harness solar energy in a different way than a standard photovoltaic panel, with the goal of reducing overall costs through optimized utilization of the photovoltaic cell, which represents the most expensive part of the system. The principle being exploited is the concentration of light radiation in the lateral zones of the panel, different from what is achieved using large light-focusing solar concentrators with waveguide effects. In their standard configuration, these luminescent concentrators consist of a “doped” glass plate with fluorescent dye molecules. The dyes absorb light of specific wavelengths from the incident sunlight and re-emit the light in all directions at longer wavelengths. A portion of this light is emitted within the critical angle of the waveguide support and is totally reflected internally and transported to the side photovoltaic module. However, these luminescent concentrators currently exhibit poor efficiency due to high reabsorption of emitted light, low coupling efficiency of light into the waveguide, and a general difficulty in trapping light within the waveguide.

### c. Technical Problems

Currently, luminescent concentrator solar panels face efficiency problems caused by various factors such as reabsorption and light dispersion in general. Another aspect that limits the efficiency in applications where luminescent concentrators are used instead of glass walls is the need for them to be semi-transparent. Consequently, a significant portion of the incident light on one wall is transmitted to the opposite wall, resulting in a decrease in the useful energy that can be concentrated. These concentrators are usually made up of a matrix in which luminescent materials are applied. The incident sunlight is converted into luminescent processes as soon as it reaches this material and can then be used in a photovoltaic module. Reabsorption of the converted light contributes significantly to energy losses in these concentrators. The transfer ratio between the incident light intensity and the light intensity received by the photovoltaic module is limited by these reabsorption effects. Current luminescent concentrators experience reabsorption effects in the luminescent materials and also dispersion through the transparent material. For these reasons, the luminescent solar panel is currently inherently energetically suboptimal.

### C1. Technical Solution

The proposed solution is to create an enhanced luminescent concentrator solar panel that absorbs all incident energy without dispersion to the opposite wall (non-semi-transparent) through a funnel concentration effect and simultaneous total reflection of energy in the concentration zone.

### d. BRIEF DESCRIPTION OF DRAWINGS

FIG. 1 General side view of the enhanced luminescent concentrator solar panel, indicating the main components of the invention: the luminescent solar concentrator part, the diffusive and reflective composite pigment, the upper reflective surface, the lower reflective base, and the photovoltaic cells.

FIG. 2 More detailed side view of the luminescent concentrator solar panel, indicating the transparent part, the diffusive layer, the reflective pigment part for concentration, the upper reflective surface, the lower reflective base, and the solar cells for electricity production.

FIG. 3 Top view of the panel showing the luminescent solar concentrator plate and the photovoltaic cells positioned on the four sides of the panel.

### KEY FIGURE SYMBOLS AND REFERENCES

1. Transparent luminescent solar panel
2. Composite pigment for diffusion and concentration of energy
2a. Diffusive and luminescent layer
2b. Non-linear reflective layer for energy concentration
3. Upper reflective layer of the panel
4. Photovoltaic surface for energy absorption
5. Photovoltaic surface for energy absorption
6. Photovoltaic surface for energy absorption
7. Photovoltaic surface for energy absorption
8. Lower reflective base of the panel

### e. Description of the Invention

The purpose of the present invention is to provide a luminescent concentrator that maximizes the utilization of solar energy by reducing reabsorption and scattering losses in luminescent concentrators for use in photovoltaic systems.

The present invention solves these problems by starting with its intended application, which is to be used as a coating for opaque surfaces, thus eliminating the need for semitransparent properties.

The luminescent concentrator converts sunlight through a composite pigment that acts as both a diffusion filter in the direction of sunlight incidence and a reflective element in the opposite direction for energy concentration.

The light diffused by the pigment is then concentrated in the underlying area through reflection between the pigment and the reflective base.

According to the present invention, a luminescent enhanced concentrator for solar light is provided.

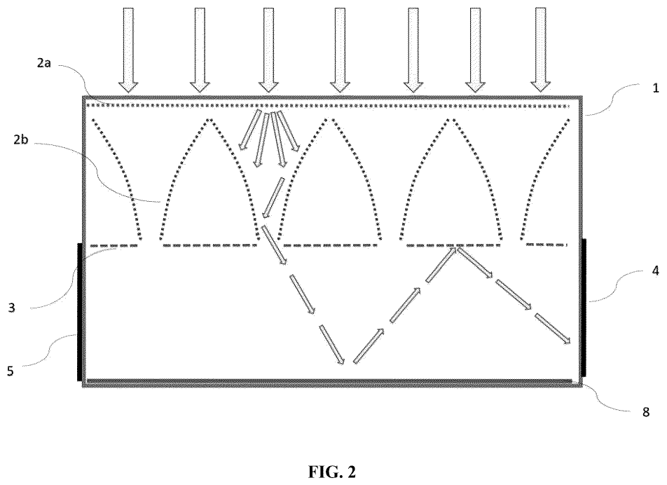

The luminescent concentrator comprises a diffusive and reflective “filter,” an energy concentration area, and a reflective base. The diffusive filter is designed to allow the passage and concentration of solar light through reflection between an upper reflective layer and the reflective surface of the base (FIG. 2).

The diffusive and reflective filter is composed of a diffusive layer with luminescent substances and a reflective zone in a particular embodiment (FIG. 2). In particular, the reflective property can be achieved by using metallic particles (e.g., silver and aluminium) and/or diffuse reflective substances (e.g., BaSO4 or TiO2).

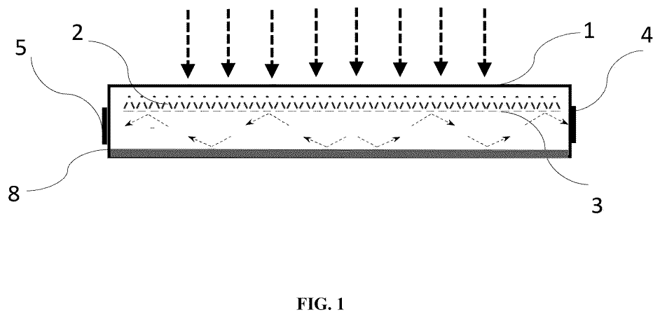

The diffusive and reflective “filter” allows the passage of incident solar light. After the light passes beyond the luminescent layer, it is not reflected back but concentrated through the reflective elements of the “filter” arranged in a specific embodiment and the reflective base of the panel (FIGS. 1 and 2).

The energy concentration area can be made of any material that does not significantly influence the concentration of light propagating through the concentration zone. Therefore, the energy concentration area does not contain light-absorbing material. In other words, the energy concentration area is essentially made of transparent material or partially void to avoid negative influences by absorbing part of the light present in the energy concentration area (FIG. 1 and FIG. 2).

By using a material that does not absorb light, the energy losses in the concentration area are minimized. Additionally, both the upper and lower layers have reflective properties, allowing the luminescent concentrator to advantageously increase the overall efficiency of a connected solar cell/photovoltaic device in the area.

The most superficial part uses a diffusive/luminescent material. A luminescent material is suitable for emitting light after absorbing sufficient energy from light or other radiation. The luminescent material contains a plurality of luminescent dye molecules. In a particular embodiment, the material is directly deposited, and with the underlying geometry and the use of reflective material, further reabsorption of incident light is minimized while the converted light is concentrated in the concentration zone (FIG. 2).

A reflective structure is adapted to reflect incident solar light. Specifically, a reflective structure reflects the vast majority of incident light. Several substances are used in a particular embodiment of the panel (FIG. 2). The reflective part can be a structure made of metallic particles or layers, such as aluminium or silver, or a diffuse substance (e.g., BaSO4 or TiO2). The reflective zone can be coated with a metallic coating or diffuse substances to provide reflectivity.

A reflective surface is used at the base of the concentrator panel to avoid energy dispersion considering the specific application.

The deposition of various substances can be carried out in a deposition chamber, such as a pulsed laser deposition (PLD) chamber, or the deposition can be performed using sputtering techniques. This type of deposition can be advantageous as it allows for the precise composition and density of the deposited material, resulting in high-quality and well-defined performance with respect to incident sunlight.

In a particular embodiment, the luminescent concentrator includes a photovoltaic device connected to the energy concentration area. A photovoltaic device can be a module or an interconnected assembly of photovoltaic cells, or even a single photovoltaic/solar cell. Photovoltaic cells are used to convert the light energy (photons) from the sun into electrical energy through the “photovoltaic effect.” Different types of solar cells can be used, such as those made of crystalline or amorphous silicon wafers or thin films, or perovskite-based cells.

By connecting the solar concentrator to the photovoltaic device, the concentrated incident solar light, as discussed above, is directed to the photovoltaic device for conversion into electricity. The arrangement of the reflective parts is such that it makes the angle of incidence of light towards the photovoltaic surfaces more perpendicular (FIG. 2). This way, through the concentration of incident light and the perpendicularity of the angle of incidence, the utilization of the photovoltaic system is optimized, increasing the overall efficiency of the system.

In a particular embodiment, the connection between the luminescent concentrator and the photovoltaic device is made optically, avoiding the use of materials that could decrease efficiency.

According to the present invention, a method for solar concentration and conversion into electrical energy is provided. The method comprises several steps: allowing incident sunlight to pass through a diffusive and reflective “filter,” an energy concentration area between two reflective zones to concentrate light in a predetermined area between the filter and the underlying surface.

In a particular embodiment, the concentrated light is directed to a photovoltaic device for conversion into electrical energy.

In summary, the luminescent concentrator and the associated method provide a means to efficiently concentrate sunlight onto a photovoltaic device, reducing energy losses and increasing the overall efficiency of solar energy conversion.

### f. Industrial Application

The present invention is innovative compared to the prior art because it allows for the creation of an enhanced luminescent concentrator solar panel (LSC) that absorbs all incident energy without semitransparency properties and maximizes the production of electrical energy.

This application is particularly effective when used as a coating for opaque “non-glazed” surfaces in a building for the generation of green energy.

This result is achieved without the need for expensive materials and equipment, thanks to the synergies of the various constituent parts. Therefore, the invention is ready for immediate industrialization.

1. This is a luminescent solar concentrator panel (FIG. 1) for solar light, composed, in order of:
a transparent layer of the panel;
a composite pigment within the transparent layer consisting of:
a diffusive/luminescent layer in the upper part,
an intermediate reflecting zone with a “funnel” geometry to convey the rays to the underlying concentration zone,
a discontinuous reflective layer in the lower part to prevent the return energy from escaping,
photovoltaic cells positioned at the edges of the transparent layer;
a fully reflective layer at the base of the panel.

2. As claimed in claim 1, the luminescent solar concentrator panel comprises a first front surface (FIG. 1) of transparent material, directly invested by the sun's rays.

3. As claimed in claims 1, the base of the panel consists of a surface capable of reflecting all the incident solar radiation, and the reflective layer is in a particular embodiment such as to increase the angle of reflection of the incident radiation (FIG. 1 and FIG. 2).

4. As claimed in claims 1 and 2, the part of the luminescent solar panel closest to the surface irradiated by sunlight is doped with a composite pigment in a particular embodiment, which in the upper part is made up of diffusive and luminescent material, with properties of filter for certain wavelengths.

5. As claimed in claims 1 and 4, the composite pigment in the intermediate zone has a particular “funnel” multiple distribution geometry with reflective capabilities that allows the diffused light to be conveyed into a smaller underlying area, so in this way it is possible to concentrate the light in the lower area of the panel (FIG. 2).

6. As claimed in claims 1, 3, 4 and 5, the lower part of the composite pigment consists of a discontinuous reflective layer:
free from pigmented areas at the small “funnel” openings of the intermediate layer where the conveyed rays converge;
In this way, the returning light cannot disperse and is reflected by the lower discontinuous reflective layer.

7. As claimed in claims 1, 3 and 6, the sunlight that is conveyed in the lower part of the panel is reflected between the base of the panel and the lower layer of the composite pigment and therefore remains confined in the concentration zone of the panel (FIG. 1) and (FIG. 2).

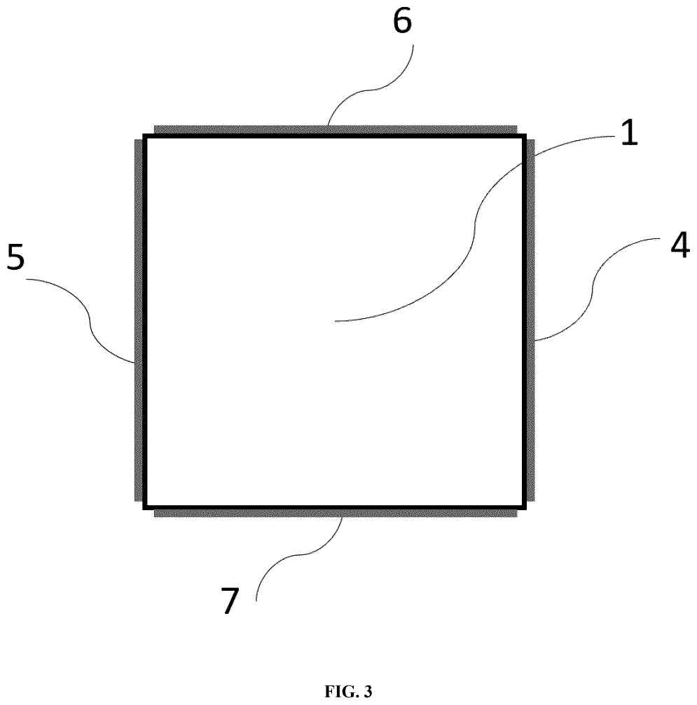

8. As claimed in claims 1, and 7, thanks to the reflection between the lower layer of the pigment and the reflecting base the light is concentrated in the lower part of the transparent material and transferred by reflection on the edges, and on the side there are photovoltaic cells which transform solar light in electricity (FIG. 1 and FIG. 3).

9. With reference to claims 1, 3 and 4, if the infrared energy is not filtered by the surface of the panel and is absorbed by the base of the panel, it allows to reduce the “urban island heat” effect.

10. As claimed in claims 1, 4, 8 and 9, the function of the luminescent solar panel of reflecting sunlight by conveying it towards the lateral solar cells, allows to:
absorb most of the light, limiting dispersion to a minimum;
reduce the effect of “urban island heat”;
produce electricity.
